(19) United States
(12) Patent Application Publication
(10) Pub. No.: US 2014/0280369 A1
(43) Pub. Date: Sep. 18, 2014

(54) CLONING TABLES AND LISTS WHILE RETAINING THE RELATIONSHIP BETWEEN ENTRY ELEMENTS AND THEIR ASSIGNED IDENTIFIERS

(71) Applicant: International Business Machines Corporation, Armonk, NY (US)

(72) Inventor: Fred Poole, San Jose, CA (US)

(21) Appl. No.: 13/831,148

(22) Filed: Mar. 14, 2013

(51) Int. Cl. G06F 17/30

(52) U.S. Cl. CPC G06F 17/30339
USPC 707/803

(57) ABSTRACT

A method, according to one embodiment, includes obtaining a list having entries corresponding to components of a first system. Moreover, the method includes determining whether an entry is missing from the list, by inserting a pseudo entry to the list for each entry that is determined to be missing from the list, thereby creating an updated list. Once the updated list is created, the method includes sending the updated list to a second system, whereupon the pseudo entries are removed from the updated list. Removing the pseudo entries thereby creates a cloned list having the same identifiers as the entries in the list from the first system.

### BACKGROUND

The present invention relates to storage systems, and more specifically, this invention relates to transferring entry lists among different storage systems by creating clones thereof.

Storage systems contain tables (also referred to herein as lists) designed to define certain storage configurations, including the mapping of certain storage resources to their corresponding host. Often, entries in the tables contain both symbolic entry elements (e.g., provided by a user), and assigned identifiers (also referred to herein as numeric identifiers), usually assigned to the entries by the system as they are created.

The numeric identifier “N” for each entry in the table is determined by the storage system in a numerical order, based on the next available position in the table. For example the first entry might have a value of N=0 (if the table entry values are 0 based), and the second entry may have a value of N=1 (=0+1), a third entry would have a value of N=2, and so on. As each entry is added to the storage system, it is assigned a value N by the system, by incrementing the N value of the immediately preceding entry by 1. Thus, the table becomes an ordered list of entries in which each entry has a unique numeric value, e.g., numeric identifier.

### BRIEF SUMMARY

A method according to one embodiment includes obtaining a list having entries corresponding to components of a first system; determining whether an entry is missing from the list; inserting a pseudo entry to the list for each entry that is determined to be missing from the list thereby creating an updated list; sending the updated list to a second system; and removing the pseudo entries from the updated list, thereby creating a cloned list having same identifiers as the entries in the list from the first system.

A computer program product according to one embodiment includes a computer readable storage medium having program code embodied therewith. The program code is readable/executable by a processor to: obtain a list having entries corresponding to components of a first system; determine whether an entry is missing from the list; insert a pseudo entry to the list for each entry that is determined to be missing from the list thereby creating an updated list; send the updated list to a second system; and remove the pseudo entries from the updated list, thereby creating a cloned list having same identifiers as the entries in the list from the first system.

A system according to yet another embodiment includes a processor and logic integrated with and/or executable by the processor. The logic is adapted to: obtain a list having entries corresponding to components of a first system; determine whether an entry is missing from the list; insert a pseudo entry to the list for each entry that is determined to be missing from the list thereby creating an updated list; send the updated list to a second system; and remove the pseudo entries from the updated list, thereby creating a cloned list having same identifiers as the entries in the list from the first system.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a flowchart of a method according to one embodiment.

FIG. 2 is a flowchart of a method according to one embodiment.

FIG. 3 illustrates a network architecture, in accordance with one embodiment.

FIG. 4 shows a representative hardware environment that may be associated with the servers and/or clients of FIG. 3, in accordance with one embodiment.

FIG. 5 illustrates a tiered data storage system in accordance with one embodiment.

FIG. 6 illustrates pseudo code in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of systems, methods and computer program products for cloning a table of elements onto a new system while retaining the relationship between entry elements and their assigned identifiers as used in the source table for an existing system. For example, a cloning tool may examine the original table and look for element entries that have been removed. When a missing entry is found, the tool will create a pseudo entry for this missing element and add it to a cloned table argument. The cloning tool may also make sure that any pre-defined reserved entry is accounted for in the table. When this modified table, with pseudo entries where needed, is used as an argument to create a cloned table on the new subsystem, the user entries may be assigned their original numeric identifiers. Once the new table has been created, the pseudo entries can then be removed. Thus, various embodiments may create a true clone of a table on a first storage system, thereby retaining the relationship between entry elements and their assigned identifiers in the cloned table that is on a second storage system.

In one general embodiment, a method includes obtaining a list having entries corresponding to components of a first system; determining whether an entry is missing from the list; inserting a pseudo entry to the list for each entry that is determined to be missing from the list thereby creating an updated list; sending the updated list to a second system; and removing the pseudo entries from the updated list, thereby creating a cloned list having same identifiers as the entries in the list from the first system.

In another general embodiment, a computer program product includes a computer readable storage medium having program code embodied therewith. The program code is readable/executable by a processor to: obtain a list having entries corresponding to components of a first system; determine whether an entry is missing from the list; insert a pseudo entry to the list for each entry that is determined to be missing from the list thereby creating an updated list; send the updated list to a second system; and remove the pseudo entries from the updated list, thereby creating a cloned list having same identifiers as the entries in the list from the first system.

In yet another general embodiment, a system includes a processor and logic integrated with and/or executable by the processor. The logic is adapted to: obtain a list having entries corresponding to components of a first system; determine whether an entry is missing from the list; insert a pseudo entry to the list for each entry that is determined to be missing from the list thereby creating an updated list; send the updated list to a second system; and remove the pseudo entries from the updated list, thereby creating a cloned list having same identifiers as the entries in the list from the first system.

In various embodiments, storage systems contain tables designed to define certain storage configurations, including the mapping of certain storage resources to their corresponding host. Often, entries in the tables contain both symbolic entry elements (e.g., provided by a user), and numeric identifiers, usually assigned to the entries by the system as they are created.

The numeric identifier for each entry “N” in the table is determined by the storage system in a numerical order, e.g., based on the next available position in the table. As each entry is added to the storage system, it is assigned a value N by the system, by updating the value of N from the previous entry. For example, which is in no way intended to limit the invention, the first entry might have a value of N=0 (if the table entry values are 0 based), the second entry may have a value of N=1 (i.e., 0+1), the third entry may have a value of N=2 (i.e., 1+2), etc. Thus, the table becomes an ordered list of entries in which each entry has a unique numeric value, e.g., numeric identifier (also referred to herein as an entry value).

However, over time, entries in the table may be deleted and/or new entries may be added, thereby causing the previously ordered list to become nonsequential. Moreover, if the nonsequential list were to be transferred to a new storage system in its present state, the new system would assign new numeric identifiers in order, based on the entries' position in the table. As a result the numeric identifiers of the new table created by the new system would not correspond to the same entries as the numeric identifiers of the original table.

To alleviate this problem, at least some of the embodiments described and/or suggested herein preferably create a true clone of a table on a first storage system, thereby retaining the relationship between entry elements and their assigned identifiers in the cloned table on a second storage system. Thus, it is desirable that a storage system may be able to recreate (e.g., clone) a first table onto a new storage system, where the clone preferably has the same symbolic entry elements associated with the same numeric identifiers as in the source table, as will be discussed in detail below.

FIG. 1 depicts a method 10 for cloning a list, in accordance with one embodiment. As an option, the present method 10 may be implemented in conjunction with features from any other embodiment listed herein, such as those described with reference to the other FIGS. Of course, however, such method 10 and others presented herein may be used in various applications and/or in permutations which may or may not be specifically described in the illustrative embodiments listed herein. Further, the method 10 presented herein may be used in any desired environment.

Referring now to FIG. 1, the method 10 includes obtaining a list having entries (also referred to herein as “entry elements”) corresponding to components of a first system. See operation 12. According to different approaches, the elements may be logical and/or physical elements, depending on the desired embodiment. Moreover, in a preferred approach, at least some of the entries in the list may be defined by a user. In other approaches, at least some of the entries in the list may be defined by a computing device, program code, data from a lookup table, etc.

The method 10 additionally includes an optional operation of sorting the list into a progressive order, e.g., using numeric identifiers. See operation 14. According to various approaches, a progressive order may include ascending, descending, odd number ascending, even number descending, etc., or any other progressive order which would be apparent to one skilled in the art upon reading the present description. In different approaches, the list may be sorted into a progressive order by a computing device, a user, a storage manager, etc.

The method 10 of FIG. 1, also includes determining whether an entry is missing from the list, e.g., because it has been removed. See operation 16. According to an exemplary approach, which is in no way intended to limit the invention, determining whether an entry is missing from the list preferably includes sequentially comparing a value corresponding to each entry (e.g., a numeric identifier), to a counter value.

As described above, a numeric identifier may be assigned to each list entry by the storage system in a progressive manner, e.g., ascending, descending, odd number ascending, even number descending, etc. Moreover, the numeric identifier assigned to a given list entry may be assigned depending on the next available identifier value at the time. Furthermore, according to various approaches, a counter value may be assigned to each entry in the list, e.g., by the storage system, a computing device, computer program product code, etc. In a preferred approach, the counter value preferably progresses in the same or similar manner to that of the numeric identifiers of the entries in the list, e.g., ascending, descending, odd number ascending, even number descending, etc. Thus, in a preferred approach, the counter values may be compared to the corresponding numeric identifier value of each entry to determine if an entry is missing. In a further approach, it may be determined that an entry is missing when the counter value is less than the value corresponding to each entry as will be explained in further detail below.

With continued reference to FIG. 1, operation 18 additionally includes inserting a pseudo entry to the list for each entry that is determined to be missing from the list (e.g., when the counter value is less than the value corresponding to each entry), thereby creating an updated list. Thus, in a preferred approach, a pseudo entry may be added to the list in an attempt to match the counter value and the entry value, e.g., to represent the missing entries in the list. According to one approach, pseudo entries may be stored in a pseudo list upon insertion thereof in the list, e.g., to assist in the deletion of the pseudo entries as will soon become apparent.

Furthermore, the method 10 includes an optional operation of detecting and keeping reserved entries in the list. See operation 20. According to different approaches, the predefined reserved entries may act as a placeholder for a user's future entry, mark the end of the list, mark a particular entry position, etc., in the updated list. Furthermore, predefined reserved entries may preferably be kept (e.g., not deleted) until they are needed and/or used.

The method 10 additionally includes sending the updated list to a second system. See operation 22. According to one approach, the second system may assign identifiers to each (e.g., all) of the entries in the updated list. In a preferred approach, the second system may use a predictor that assigns identifiers in the same and/or similar way as they are assigned in the first system. Thus, in a preferred approach, the identifiers of the entries on the updated list have the same progression as the identifiers of the entries on the list (e.g., from the first system).

Moreover, operation 24 of FIG. 1 includes removing the pseudo entries and the identifiers assigned thereto from the updated list, thereby creating a cloned list having the same identifiers as the entries in the list from the first system. In a preferred approach, the pseudo list may be used when removing the pseudo entries and/or the identifiers assigned thereto from the list, e.g., to increase speed, accuracy, etc. of cloning the list. In different approaches, the pseudo list may store the pseudo entries' locations and/or number thereof.

According to another approach, each of the entries in the updated list may be tested, e.g., to determine whether there are pseudo entries therein. Moreover, when a pseudo entry is found, it is preferably removed from the updated list.

In a preferred approach, predefined reserved entries in the cloned list may be maintained, e.g., transferred from the previous list. As described above, according to different approaches, the predefined reserved entries may act as a placeholder for a user's future entry, mark the end of the list, mark a particular entry position, etc., in the cloned list. Furthermore, predefined reserved entries may preferably be kept (e.g., not deleted) until they are needed and/or used.

FIG. 2 depicts a method 50 for cloning a first system, in accordance with one embodiment. As an option, the present method 50 may be implemented in conjunction with features from any other embodiment listed herein, such as those described with reference to the other FIGS. Of course, however, such method 50 and others presented herein may be used in various applications and/or in permutations which may or may not be specifically described in the illustrative embodiments listed herein. Further, the method 50 presented herein may be used in any desired environment. Thus FIG. 2 (and the other FIGS.) should be deemed to include any and all possible permutations.

Referring now to FIG. 2, the method 50 includes an optional operation of ensuring that the second system has about an identical physical configuration, and preferably an identical physical configuration, at least in terms of capability to provide physical resources, as the first system. See operation 52. According to different approaches, physical resources may include, but are not limited to, arrays, data storage drives, memory, controllers, network interface devices, etc.

The method 50 additionally includes reading configuration data of the first system for determining the components. See operation 54. According to an exemplary approach, a “list and show” process may be used when reading the configuration data.

Moreover, operation 56 of method 50 includes creating corresponding resources on the second system using the cloned list.

Again, the method 50 may include any of the approaches described and/or suggested herein according to various approaches.

According to an illustrative use embodiment, which is in no way intended to limit the invention, a list in a first system may include 11 sequential entries each having an assigned identifier that is 0 based, as depicted below. Also refer back to operation 12 of FIG. 1.

As shown in the illustrative list below, each entry has its own symbolic entry element (e.g., a textual and/or numerical name or identifier defined by a user), denoted in this example by the prefix “user_entry_element”. Furthermore, each entry has its own numeric identifier, assigned by the first system and denoted by the prefix “assigned_id_”. It is also noted that the 10^{th} entry (“reserved”) is a reserved entry.

| | |
|---|---|
| user_entry_element0 | assigned_id_0 |
| user_entry_element1 | assigned_id_1 |
| user_entry_element2 | assigned_id_2 |
| user_entry_element3 | assigned_id_3 |
| user_entry_element4 | assigned_id_4 |
| user_entry_element5 | assigned_id_5 |
| user_entry_element6 | assigned_id_6 |
| user_entry_element7 | assigned_id_7 |
| user_entry_element8 | assigned_id_8 |
| reserved | assigned_id_9 |
| user_entry_element10 | assigned_id_10 |

However, over time, some of the entries may be removed from the list as illustrated below. For example, assume user entry elements 2, 4 and 6 have been removed from the system. Accordingly, their entries (the 3^{rd}, 5^{th} and 7^{th} entries) are removed from the list.

| | |
|---|---|
| user_entry_element0 | assigned_id_0 |
| user_entry_element1 | assigned_id_1 |
| user_entry_element3 | assigned_id_3 |
| user_entry_element5 | assigned_id_5 |
| user_entry_element7 | assigned_id_7 |
| user_entry_element8 | assigned_id_8 |
| reserved | assigned_id_9 |
| user_entry_element10 | assigned_id_10 |

Thus the resulting list now has 8 entries rather than the initial 11. Note that the assigned id's are no longer sequential.

| | |
|---|---|
| user_entry_element0 | assigned_id_0 |
| user_entry_element1 | assigned_id_1 |
| user_entry_element3 | assigned_id_3 |
| user_entry_element5 | assigned_id_5 |
| user_entry_element7 | assigned_id_7 |
| user_entry_element8 | assigned_id_8 |
| reserved | assigned_id_9 |
| user_entry_element10 | assigned_id_10 |

As illustrated above, both the symbolic entry elements of the entries and the numeric identifiers assigned thereto remain the same for their respective elements, even though certain entries have been removed. It follows that, to create a true clone of this list on a new system, counter values are preferably used, e.g., to determine whether there are any previously deleted entries. As depicted below, counter values are associated to each of the entries with the same progression as the numeric identifiers assigned thereto by the first system. Also refer back to operation 16 of FIG. 1.

| | | |
|---|---|---|
| user_entry_element0 | assigned_id_0 | counter_0 |
| user_entry_element1 | assigned_id_1 | counter_1 |
| user_entry_element3 | assigned_id_3 | counter_2 |
| user_entry_element5 | assigned_id_5 | counter_3 |
| user_entry_element7 | assigned_id_7 | counter_4 |
| user_entry_element8 | assigned_id_8 | counter_5 |
| reserved | assigned_id_9 | counter_6 |
| user_entry_element10 | assigned_id_10 | counter_7 |

Thus, the counter values may be compared to the numeric identifiers assigned to the entries by the first system to account for any previously deleted entries. As shown below, it may be determined that an entry is missing (e.g., was previously deleted) when the counter value is less than the numeric identifier corresponding to each entry. For example, looking to the third entry of the list,

| | | |
|---|---|---|
| user_entry_element3 | assigned_id_3 > | counter_2 |

Thus, it can be determined that an entry is missing (e.g., was previously deleted) before the third entry of the list because the counter value is less than the numeric identifier. As a result, a pseudo entry may be added to the list for each entry that is determined to be missing. Also refer back to operation 18 of FIG. 1. Moreover, each pseudo entry may be added to a pseudo list, e.g., to assist in deleting said pseudo entries, as will soon become apparent.

| | | |
|---|---|---|
| user_entry_element0 | assigned_id_0 | counter_0 |
| user_entry_element1 | assigned_id_1 | counter_1 |
| pseudo_entry2 | | counter_2 |
| user_entry_element3 | assigned_id_3 | counter_3 |
| pseudo_entry4 | | counter_4 |
| user_entry_element5 | assigned_id_5 | counter_3 |
| pseudo_entry6 | | counter_6 |
| user_entry_element7 | assigned_id_7 | counter_7 |
| user_entry_element8 | assigned_id_8 | counter_8 |
| reserved | assigned_id_9 | counter_9 |
| user_entry_element10 | assigned_id_10 | counter_10 |

Thus, each of the list's entries have been accounted for. The list may then be transferred to the second system where the second system assigns each entry a numeric identifier, while maintaining the symbolic entry elements (e.g., defined by a user) of the first system.

| | |
|---|---|
| user_entry_element0 | assigned_id_0 |
| user_entry_element1 | assigned_id_1 |
| pseudo_entry2 | assigned_id_2 |
| user_entry_element3 | assigned_id_3 |
| pseudo_entry4 | assigned_id_4 |
| user_entry_element5 | assigned_id_5 |
| pseudo_entry6 | assigned_id_6 |
| user_entry_element7 | assigned_id_7 |
| user_entry_element8 | assigned_id_8 |
| reserved | assigned_id_9 |
| user_entry_element10 | assigned_id_10 |

Once the second system assigns each entry a numeric identifier, the pseudo entries may be removed, e.g., by using the pseudo list, thereby producing a true clone of the list on the first system and retaining the relationship between entry elements and their assigned identifiers. Also refer back to operation 24 of FIG. 1. It is also noted that the reserved entry in the list has been preserved in the cloned list (refer back to operation 20 of FIG. 1).

| | |
|---|---|
| user_entry_element0 | assigned_id_0 |
| user_entry_element1 | assigned_id_1 |
| user_entry_element3 | assigned_id_3 |
| user_entry_element5 | assigned_id_5 |
| user_entry_element7 | assigned_id_7 |
| user_entry_element8 | assigned_id_8 |
| reserved | assigned_id_9 |
| user_entry_element10 | assigned_id_10 |

According to another embodiment, pseudo code, and/or any other high level programming code which would be apparent to one skilled in the art upon reading the present description, may be used to create a true clone of a given list.

Moreover, with reference now to another exemplary embodiment, which is presented as an example that is in no way intended to limit the invention, some, any and/or all of the pseudo code 600 shown in FIG. 6 may be used to clone a list.

With reference to FIG. 6, in Step 1, the original table of physical, logical, etc. elements is read in. The resulting table is sorted in numeric ascending order, descending order, even ascending order, etc. The counter_value is set to 0, 1, etc., according to whichever numbering convention is being used. The counter_value is compared to each of the entries in the table. If the counter_value is equal to a reserved entry value position of a given entry in the table, then the entry position is skipped and the system will automatically assign this the entry position a value, e.g., when creating the new table. Once the entry position is skipped, counter_value is incremented, and the next entry value position in the table is compared to the counter_value. However, if the current entry has a higher value than counter_value when the counter_value is compared to an entry in the table, then a pseudo entry is added to the table (e.g., see operation 18 of FIG. 1). The pseudo entry is then saved in a pseudo_list, and the counter_value is incremented. However, in an alternate approach, if the current entry has a higher value than counter_value, the current entry may be saved in the new table, and the counter value incremented. Once each of the entries in the table have been evaluated, Step 1 is completed.

With continued reference to FIG. 6, in Step 2, once the new table has been created on the new system, the pseudo_list is then used, e.g., to remove the pseudo entries created in Step 1. For the new table, each of the entries are tested, e.g., if a current entry of each of the entries is a pseudo entry. If an entry is found to be a pseudo entry, then that entry is deleted from the new table. Once each of the entries in the new table have been evaluated, Step 2 is completed.

As a result, according to a preferred embodiment, the pseudo code above may create a cloned list of elements on a second system where each entry has the same identifiers (e.g., symbolic entry components and/or numeric identifiers) as in the first system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic,” “circuit,” “module” or “system.”Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, processor, or device.

A computer readable signal medium may include a propagated data signal with computer readable program code embodied therein, for example, in baseband, as part of a carrier wave, an electrical connection having one or more wires, an optical fiber, etc. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

FIG. 3 illustrates an architecture 100, in accordance with one embodiment. As shown in FIG. 3, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a LAN, a WAN such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX system which emulates an IBM z/OS environment, a UNIX system which virtually hosts a MICROSOFT WINDOWS environment, a MICROSOFT WINDOWS system which emulates an IBM z/OS environment, etc. This virtualization and/or emulation may be enhanced through the use of VMWARE software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

FIG. 4 shows a representative hardware environment associated with a user device 116 and/or server 114 of FIG. 3, in accordance with one embodiment. Such figure illustrates a typical hardware configuration of a workstation having a central processing unit 210, such as a microprocessor, and a number of other units interconnected via a system bus 212.

The workstation shown in FIG. 4 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a MAC OS, a UNIX OS, etc. It will be appreciated that a preferred embodiment may also be implemented on platforms and operating systems other than those mentioned. A preferred embodiment may be written using JAVA, XML, C, and/or C++ language, or other programming languages, along with an object oriented programming methodology. Object oriented programming (OOP), which has become increasingly used to develop complex applications, may be used.

Now referring to FIG. 5, a storage system 300 is shown according to one embodiment. Note that some of the components shown in FIG. 5 may be implemented as hardware and/or software, according to various embodiments. The storage system 300 may include a storage system manager 312 for communicating with a plurality of media on a higher storage tier 302 and a lower storage tier 306. The higher storage tier 302 preferably may include one or more random access and/or direct access media 304, such as hard disks in hard disk drives (HDDs), nonvolatile memory (NVM), solid state memory in solid state drives (SSDs), etc., and/or others noted herein. The lower storage tier 306 may preferably include one or more sequential access media 308, such as magnetic tape in tape drives, optical media, etc., and/or others noted herein. Additional storage tiers 316 may include any combination of storage memory media. The storage system manager 312 may communicate with the storage media 304, 308 on the higher and lower storage tiers 302, 306 through a network 310, such as a storage area network (SAN), as shown in FIG. 5. The storage system manager 312 may also communicate with one or more host systems (not shown) through a host interface 314, which may or may not be a part of the storage system manager 312. The storage system manager 312 and/or any other component of the storage system 300 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 300 may include any number of data storage tiers, and may include the same or different storage memory media within each storage tier. For example, each data storage tier may include the same type of storage memory media, such as HDDs, SSDs, sequential access media (tape in tape drives, optical disk in optical disk drives, etc.), direct access media (CD-ROM, DVD-ROM, etc.), or any combination of media storage types. In one such configuration, a higher storage tier 302, may include a majority of SSD storage media for storing data in a higher performing storage environment, and remaining storage tiers, including lower storage tier 306 and additional storage tiers 316 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 302, while data not having one of these attributes may be stored to the additional storage tiers 316, including lower storage tier 306. Of course, one of skill in the art, upon reading the present descriptions, may devise many other combinations of storage media types to implement into different storage schemes, according to the embodiments presented herein.

According to some embodiments, the storage system (such as 300) may include logic adapted to receive a request to open a data set, logic adapted to determine if the requested data set is stored to a lower storage tier 306 of a tiered data storage system 300 in multiple associated portions, logic adapted to move each associated portion of the requested data set to a higher storage tier 302 of the tiered data storage system 300, and logic adapted to assemble the requested data set on the higher storage tier 302 of the tiered data storage system 300 from the associated portions.

Of course, this logic may be implemented as a method on any device and/or system or as a computer program product, according to various embodiments.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
obtaining a list having entries corresponding to components of a first system;
determining whether an entry is missing from the list;
inserting a pseudo entry to the list for each entry that is determined to be missing from the list thereby creating an updated list;
sending the updated list to a second system; and
removing the pseudo entries from the updated list, thereby creating a cloned list having same identifiers as the entries in the list from the first system.

2. The method of claim 1, further comprising maintaining predefined reserved entries in the cloned list.

3. The method of claim 1, wherein at least some of the entries in the list are defined by a user.

4. The method of claim 1, wherein determining whether an entry is missing from the list comprises: sequentially comparing a value corresponding to each entry to a counter value, determining that an entry is missing when the counter value is less than the value corresponding to each entry.

5. The method of claim 1, further comprising storing the pseudo entry in a pseudo list upon insertion thereof in the list; and using the pseudo list when removing the pseudo entries from the list.

6. The method of claim 1, wherein the second system assigns identifiers to all of the entries in the updated list.

7. The method of claim 1, further comprising performing operations for cloning a first system, said operations comprising:
reading configuration data of the first system for determining the components; and
creating corresponding resources on the second system using the cloned list.

8. A computer program product comprising a computer readable storage medium having program code embodied therewith, the program code readable/executable by a processor to:
obtain a list having entries corresponding to components of a first system;
determine whether an entry is missing from the list;
insert a pseudo entry to the list for each entry that is determined to be missing from the list thereby creating an updated list;
send the updated list to a second system; and
remove the pseudo entries from the updated list, thereby creating a cloned list having same identifiers as the entries in the list from the first system.

9. The computer program product of claim 8, wherein the program code is further readable/executable by the processor to maintain predefined reserved entries in the cloned list.

10. The computer program product of claim 8, wherein at least some of the entries in the list are defined by a user.

11. The computer program product of claim 8, wherein the program code for determining whether an entry is missing from the list comprises: program code to sequentially compare a value corresponding to each entry to a counter value, and program code to determine that an entry is missing when the counter value is less than the value corresponding to each entry.

12. The computer program product of claim 8, wherein the program code is further readable/executable by the processor to store the pseudo entry in a pseudo list upon insertion thereof in the list; and use the pseudo list when removing the pseudo entries from the list.

13. The computer program product of claim 8, wherein the second system assigns identifiers to all of the entries in the updated list.

14. The computer program product of claim 8, wherein the program code is further readable/executable by the processor to perform operations for cloning a first system, said operations comprising:
read configuration data of the first system for determining the components; and
create corresponding resources on the second system using the cloned list.

15. A system, comprising:
a processor and logic integrated with and/or executable by the processor, the logic being adapted to:
obtain a list having entries corresponding to components of a first system;
determine whether an entry is missing from the list;
insert a pseudo entry to the list for each entry that is determined to be missing from the list thereby creating an updated list;
send the updated list to a second system; and
remove the pseudo entries from the updated list, thereby creating a cloned list having same identifiers as the entries in the list from the first system.

16. The system as recited in claim 15, further comprising logic adapted to maintain predefined reserved entries in the cloned list.

17. The system as recited in claim 15, wherein the logic adapted to determine whether an entry is missing from the list comprises: logic adapted to sequentially compare a value corresponding to each entry to a counter value, and logic adapted to determine that an entry is missing when the counter value is less than the value corresponding to each entry.

18. The system as recited in claim 15, further comprising logic adapted to store the pseudo entry in a pseudo list upon insertion thereof in the list; and use the pseudo list when removing the pseudo entries from the list.

19. The system as recited in claim 15, wherein the second system assigns identifiers to all of the entries in the updated list.

20. The system as recited in claim 15, further comprising logic adapted to perform operations for cloning a first system, said operations comprising:
read configuration data of the first system for determining the components; and
create corresponding resources on the second system using the cloned list.
